(19) United States
(12) Patent Application Publication
(10) Pub. No.: US 2009/0092832 A1
(43) Pub. Date: Apr. 9, 2009

(54) GLASS FIBRES COATED WITH SIZE CONTAINING NANOPARTICLES

(75) Inventor: Patrick Moireau, Curienne (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN TECHNICAL FABRICS EUROPE, Chambery (FR)

(21) Appl. No.: 12/158,470

(22) PCT Filed: Dec. 18, 2006
(86) PCT No.: PCT/FR06/51374

§ 371 Date: Sep. 24, 2008

(30) Foreign Application Priority Data
Dec. 23, 2005 (FR) 0554077

(51) Int. Cl. B32B 17/02; C08K 7/16

(52) U.S. Cl. 428/378; 428/375; 524/445

(57) ABSTRACT

The invention relates to glass strands coated with a sizing composition which comprises (in % by weight):
25 to 90% of at least one film-forming agent;
3 to 25% of at least one coupling agent; and
2 to 18% of nanoparticles.

The invention also relates to a sizing composition that can coat said strands, to the method of obtaining it and to the composites incorporating such strands.

The glass strands of the invention have a high wet aging resistance.

The present invention relates to glass strands coated with a size containing nanoparticles, especially clay, boehmite or silica nanoparticles, intended for the reinforcement of organic and/or inorganic materials.

The invention also relates to the sizing composition used to coat said strands, to the method for preparing said composition and to the composites incorporating said strands.

Conventionally, glass reinforcing strands are produced by mechanically attenuating molten glass streams flowing out from numerous orifices in a bushing filled with molten glass, under gravity, through the effect of the hydrostatic pressure due to the height of the liquid, in order to form filaments that are assembled into base strands, said strands then being collected on a suitable support.

During the attenuation, and before they are assembled into strands, the glass filaments are coated with a sizing composition, generally an aqueous composition, by passing them over a sizing member.

The size is essential on several counts.

During manufacture of the strands, it protects the filaments from the abrasion that results from them rubbing, at high speed, on the members for attenuating and winding the strand by acting as a lubricant. The size also provides the strand with cohesion, by ensuring that the filaments are linked together. Finally, it makes the strand sufficiently integral to withstand the rewinding operations necessary for forming, in particular, “assembled” rovings from several base strands, and it also makes it possible to eliminate the electrostatic charges generated during these operations.

During use for the purpose of producing composites, the size improves the impregnation of the strand by the matrix to be reinforced and it promotes adhesion between the glass and said matrix, thus resulting in composites with improved mechanical properties. Furthermore, the size protects the strands from chemical and environmental attack, thereby helping to increase their durability. In applications requiring the strand to be chopped, the size prevents the filaments from splaying out and separating, and, together with the oversize, it contributes to dispersing the electrostatic charges generated during chopping.

The glass strands in their various forms (continuous, chopped or ground strands, mats, meshes, wovens, knits, etc.) are commonly used for the effective reinforcement of matrices of various types, for example thermoplastic or thermosetting organic materials and inorganic materials, for example cement.

One object of the present invention is to improve the abrasion resistance of glass strands coated with a size, especially so as to allow them to be woven under better conditions.

Another object of the invention is to improve the wet aging resistance of glass strands coated with a size that are intended to be incorporated as elements for reinforcing polymer materials, especially thermoplastics or thermosets, and/or inorganic materials.

These objects are achieved according to the invention by glass strands coated with a sizing composition that contains nanoparticles.

More precisely, one subject of the invention is a glass strand coated with a sizing composition, especially obtained from an aqueous dispersion and/or an aqueous suspension and/or an aqueous emulsion, which comprises (in % by weight):
25 to 90% of at least one film-forming agent;
3 to 25% of at least one coupling agent; and
2 to 18% of nanoparticles.

In the present invention, the term “nanoparticles” is understood to mean particles of a material that are formed from a cluster of atoms or molecules, having one or more dimensions that may vary between 1 and 100 nanometers, preferably between 1 and 50 nanometers. The shape of these particles may vary widely, for example they may have the appearance of a sphere, a tube, a whisker, a flake or a platelet.

Again within the context of the invention, the term “strands” should be understood to mean the base strands resulting from the assembly of a multitude of filaments, and the products derived from these strands, especially assemblies of these base strands in the form of rovings. Such assemblies may be obtained by simultaneously paying out base strands from several packages and then assembling said strands into tows that are wound onto a rotating support. They may also be “direct’ rovings with a titer (or linear density) equivalent to that of assembled rovings obtained by gathering the filaments directly beneath the bushing and winding onto a rotating support.

Also according to the invention, the expression “aqueous sizing composition” is understood to mean a composition that can be deposited on the filaments during attenuation, which composition is in the form of a suspension or dispersion comprising at least 70%, preferably 75%, by weight of water and possibly containing, where appropriate, less than 10%, preferably less than 5%, by weight of one or more essentially organic solvents helping to dissolve certain constituents of the sizing composition. In the majority of cases, the composition contains no organic solvent, especially so as to limit the emission of volatile organic compounds (VOCs) into the atmosphere.

The film-forming agent according to the invention acts in several ways: it gives the coating mechanical cohesion, by making the nanoparticles adhere to the glass filaments and ensuring that these nanoparticles are linked together, where appropriate with the material to be reinforced; it helps to bind the filaments together; finally, it protects the strands from any mechanical damage and from chemical and environmental attack.

The film-forming agent is a polymer chosen from polyvinyl acetates (homopolymers or copolymers, for example vinyl acetate/ethylene copolymers), polyesters, epoxies, polyacrylics (homopolymers or copolymers), polyurethanes, polyamides (homopolymers or copolymers, for example polyamide/polystyrene or polyamide/polyoxyethylene block copolymers), cellulose polymers and blends of these compounds. Polyvinyl acetates, epoxies, blends containing at least one epoxy and at least one polyester, and polyurethanes are preferred.

Preferably, the amount of film-forming agent represents from 50 to 90% by weight of the sizing composition.

The coupling agent ensures that the sizing agent attaches to the surface of the glass.

The coupling agent is chosen from hydrolyzable compounds, especially in the presence of an acid, such as acetic, lactic or citric acid, which belong to the group formed by silanes, such as γ-glycidoxypropyltrimethoxysilane, γ-acryloxypropyltrimethoxysilane, γ-methacryloxypropyltri methoxysilane, poly(oxyethylene/oxypropylene)trimethoxysilane, γ-aminopropyltriethoxysilane, vinyltrimethoxysilane, phenylaminopropyltrimethoxysilane or styrylaminoethylaminopropyltrimethoxysilane, siloxanes, titanates, zirconates and mixtures of these compounds. Preferably, silanes are chosen.

Preferably, the amount of coupling agent represents from 5 to 18% by weight of the sizing composition.

The nanoparticles are essential to the size. This is because the incorporation of nanoparticles into the size proves to be highly beneficial for reducing abrasion effects both during manufacture of the strand, when the constituent filaments of the strand run at high speed over a multitude of members used for guiding and assembling them, and during its conversion, in particular by weaving, when the strand must be able to withstand high tensile and frictional forces.

Another advantage of nanoparticles is their contribution to the water and gas barrier effect. This is because nanoparticles are obstacles that prevent rapid penetration of water and gases by creating tortuous diffusion paths in the glass, which is thus better protected. The degree of protection varies according to the amount and the shape of the nanoparticles in the size.

Particles of various dimensions may give the aforementioned effects. In this regard, nanoparticles having a high aspect ratio (ratio of the longest dimension to the smallest dimension) such as platelets are particularly suitable as they are able to be oriented parallel to the surface of the filaments. This gives the strand greater wet aging resistance Approximately spherical nanoparticles such as beads may also be chosen.

The nanoparticles according to the invention are composed of a mineral materal i.e. they contain more than 30%, preferably more than 40% and advantageously more than 45% by weight of such a material.

Preferably, the nanoparticles are based on clay, boehmite or silica.

The term “clay” here should be considered in its general definition accepted by those skilled in the art, namely it defines hydrated aluminosilicates of general formula Al₂O₃.SiO₂.xH₂O, where x is the degree of hydration. Such a clay consists of aluminosilicate sheets having a thickness of a few nanometers linked together by hydrogen bonds or ionic bonds between the hydroxide groups present on the sheets and the water and/or the cations present between said sheets.

Examples that may be mentioned include mica-type phyllosilicates, such as smectites, montmorillonite, hectorite, bentonites, nontronite, beidellite, volonskoite, saponite, sauconite, magadiite, vermiculite, mica, kenyaite and synthetic hectorites.

Preferably, the clay is chosen from 2/1-type phyllosilicates, advantageously smectites. The particularly preferred clay is montmorillonite.

The clay may be a calcined clay, for example one having undergone a heat treatment at a temperature of at least 750° C.

They clay may also be a modified clay, for example one modified by cationic exchange in the presence of a solution of an ammonium, phosphonium, pyridinium or imidazolium salt, preferably an ammonium salt.

The clay nanoparticles are generally present in the form of platelets having a thickness of a few nanometers and a length that may be up to 1 micron, generally less than 100 nanometers, it being possible for these platelets to be individual platelets or aggregates.

The clay nanoparticles may be obtained by subjecting a clay, possibly calcined and/or modified as mentioned above, to the action of at least one expansion agent, which has the function of separating the clay sheets. For example, the expansion agent may be tetrahydrofuran or an alcohol, such as ethanol, isopropanol, ethylene glycol, 1,3-propanediol, 1,4-butanediol and polyethylene glycols, especially one with a molecular weight of less than 1200.

The term “boehmite” relates to alumina monohydrates. Preferably, the boehmite is a synthetic boehmite obtained by a hydrothermal reaction starting from an aluminum hydroxide.

The boehmite nanoparticles may be in the form of beads, needles, ellipsoids or platelets, the latter form being preferred.

The silica is preferably amorphous.

The silica particles are preferably in the form of beads. Advantageously, the beads have a diameter between 5 and 35 nm, and preferably a mean diameter of around 15 to 20 nm.

Advantageously, the nanoparticles are treated with an agent that contributes to slowing down the rate of diffusion of water and gases and thus helps to increase the aging resistance of the strand in a wet environment. Preferably, such an agent is hydrophobic.

Methods for rendering particles hydrophobic are known.

For example, the nanoparticles may be made to react with a compound of formula RₐXY₄₋ₐ in the presence of water and an acid, in which formula:

R represents a hydrogen atom or a hydrocarbon radical containing 1 to 40 carbon atoms, it being possible for said radical to be linear, branched or cyclic, saturated or unsaturated, possibly containing one or more O or N heteroatoms or possibly being substituted with one or more amino, carboxylic acid, epoxy or amido groups, and the R groups being identical or different;

X represents Si, Zr or Ti;

Y is a hydrolyzable group, such as an alkoxy containing 1 to 12 carbon atoms, possibly containing one or more heteroatoms O or N or a halogen, preferably Cl; and

a is equal to 1, 2 or 3.

Preferably, the compound satisfying the aforementioned formula is an organosilane, advantageously an organosilane containing two or three alkoxy groups.

Examples that may be mentioned include: γ-aminopropyltrimethoxysilane, γ-aminopropyltriethoxysilane, N-phenyl-γ-aminopropyltrimethoxysilane, N-styrylaminoethyl-γ-aminopropyltrimethoxysilane, γ-glycidoxypropyltrimethoxysilane, γ-methacryloxypropyltrimethoxysilane, γ-acryloxypropyltrimethoxysilane, vinyltrimethoxysilane, vinyltriethoxysilane, tert-butylcarbamoylpropyltrimethoxysilane, and γ-(polyalkyleneoxyde)propyltrimethoxysilanes.

Preferably, γ-aminopropyltriethoxysilane, N-phenyl-γ-aminopropyltrimethoxysilane, N-styrylaminoethyl-γ-aminopropyltrimethoxysilane, γ-glycidoxypropyltrimethoxysilane and γ-methacryloxypropyltrimethoxysilane.

The grafting agent is added in an amount representing from 15 to 75% by weight, preferably 30 to 70%, by weight of the initial nanoparticles.

The nanoparticle content in the sizing composition preferably varies from 2.5 to 15% and advantageously from 4 to 14%.

In addition to the aforementioned constituents that essentially participate in the structure of the size, one or more other constituents may be present.

Thus, it is possible to introduce a plasticizer, which lowers the glass transition temperature of the film-forming agent, thereby giving the size flexibility and limiting the shrinkage after drying.

The size may include a dispersing agent, which helps in dispersing the nanoparticles and promotes compatibility between the other constituents and water.

The dispersing agent may be chosen from:

organic compounds, in particular:
optionally halogenated, aliphatic or aromatic, polyalkoxylated compounds, such as ethoxylated/propoxylated alkylphenols, preferably containing 1 to 30 ethylene oxide groups and 0 to 15 propylene oxide groups, ethoxylated/propoxylated bisphenols, preferably containing 1 to 40 ethylene oxide groups and 0 to 20 propylene oxide groups, ethoxylated/propoxylated fatty alcohols, preferably the alkyl chain of which comprises 8 to 20 carbon atoms, and containing 2 to 50 ethylene oxide groups and up to 20 propylene oxide groups. These polyalkoxylated compounds may be block copolymers or random copolymers,
polyalkoxylated fatty acid esters, for example polyethyleneglycol, the alkyl chain of which preferably comprises 8 to 20 carbon atoms, and containing 2 to 50 ethylene oxide groups and up to 20 propylene oxide groups and
amine compounds, for example optionally alkoxylated amines, amine oxides, alkylamides, sodium, potassium or ammonium succinates and taurates, sugar derivatives, especially sorbitan, and sodium, potassium or ammonium alkyl sulfates, optionally alkoxylated, alkyl phosphates and ether phosphates; and

inorganic compounds, for example silica derivatives, these compounds possibly being used by themselves or as a mixture with the aforementioned organic compounds.

To prevent the sizing composition from having stability problems and to prevent the nanoparticles being inhomogeneously dispersed, it is preferred to use cationic or nonionic surfactants.

Preferably, the amount of dispersing agent represents from 0.01 to 60%, preferably from 0.25 to 50%, of the weight of the nanoparticles.

It is also possible to introduce a viscosity-regulating agent, which makes it possible to adjust the viscosity of the composition to the conditions of application to the filaments, which viscosity is in general between 5 and 80 mPa.s, preferably at least 7 mpa.s. This agent also makes it possible to adapt the viscosity of the nanoparticle dispersions so as to allow them to be treated under high shear conditions so as to improve their state of exfoliation, as will be explained in the rest of the text.

The viscosity-regulating agent is chosen from polyvinyl-alcohols, polyvinylpyrrolidones, hydroxymethylcelluloses, carboxymethylcelluloses and polyethylene glycols.

The amount of regulating agent in the size is preferably between 0.5 and 25% and advantageously between 1.5 and 18%.

The size may also include:
0.5 to 20%, preferably 1.5 to 15%, by weight of a lubricating agent, for example a mineral oil, a fatty acid ester, such as isopropyl palmitate or butyl stearate, an alkylamine or a polyethylene wax;
0.25 to 20%, preferably 0.5 to 15%, by weight of a complexing agent such as an EDTA derivative, gallic acid or phosphoric acid; and
0.05 to 3%, preferably 0.1 to 1.5%, by weight of an antifoaming agent, such as a silicone, a polyol or vegetable oil.

All of the above compounds contribute to the production of glass strands that can be easily manufactured, are able to be used as reinforcements, and which are incorporated without any problems into the resin during manufacture of the composites and also possess high resistance to abrasion and to aging in a wet environment.

As a general rule, the amount of size represents 0.2 to 5%, preferably 0.35 to 3%, of the weight of the final strand.

The sized strand according to the invention may be made of glass of any kind, for example E, C, R, AR and glass with a low boron content (less than 6%). E and AR are preferred.

The diameter of the glass filaments constituting the strands may vary widely, for example from 5 to 30 μm. Likewise, wide variations may occur in the linear density of the strand, which may range from 11 to 4800 tex depending on the intended applications.

Another subject of the invention is the sizing composition that can be deposited on the glass filaments. It comprises the aforementioned constituents and water.

The aqueous sizing composition comprises (in % by weight):
1.5 to 15%, preferably 2.5 to 10%, of at least one film-forming agent;
0.15 to 4%, preferably 0.25 to 2.5%, of at least one coupling agent;
0.1 to 4%, preferably 0.15 to 2%, of nanoparticles;
0 to 2%, preferably 0.1 to 1.2%, of at least one lubricating agent;
0 to 4%, preferably 0.05 to 2%, of at least one dispersing agent; and
0 to 4%, preferably 0.05 to 2%, of at least one viscosity-regulating agent.

The amount of water to be used is determined so as to obtain a solids content that varies from 2 to 35%, preferably 2.5 to 25% and better still 3 to 15%.

The preparation of the sizing composition is carried out as follows:

a) producing a dispersion D of the nanoparticles in water preferably containing a dispersing agent;

b) introducing the other components of the size, namely the film-forming agent, the coupling agent and the aforementioned optional constituents, in water in order to form an emulsion E, and

c) blending the dispersion D with the emulsion E.

Advantageously, steps a) and c) are carried out with sufficient stirring to avoid the risk of nanoparticle sedimentation.

The dispersion of nanoparticles based on a sheet-like material, that is clay or boehmite, may be obtained in various ways, all having the purpose of increasing the degree of exfoliation of the material.

According to a first embodiment, the nanoparticles are introduced into water containing a dispersing agent, and the mixture is treated under high shear conditions for example in an Ultraturaxe device and/or subjected to the action of ultrasound.

To give an indication, a good nanoparticle dispersion is obtained by treating the mixture in an Ultraturax® operating at a speed of 3000 to 10000 rpm for 5 to 30 minutes or by ultrasound with a power of 200 W and a frequency of 20 kHz for 15 to 120 minutes.

Preferably, a polymer agent chosen from the aforementioned film-forming agents is added to the mixture.

Advantageously, a viscosity-regulating agent is introduced into the mixture before the treatment, in particular when subjecting the nanoparticles to shear.

According to a second embodiment, the nanoparticles are mixed with granules of a thermoplastic polymer, such as a polyvinyl acetate, a polyamide and a polyurethane, or a thermoset, such as an epoxy, phenolic or acrylic resin, and a polyurethane, and the mixture is introduced into an extruder. The extrudates are then emulsified in an essentially aqueous medium under conditions known to those skilled in the art. This embodiment also applies to nanoparticles in the form of silica beads, the preferred resin being in this case an epoxy or acrylic resin.

As mentioned previously, the aqueous sizing composition is deposited on the filaments before they are assembled into base strand(s). The water is usually removed by drying the strands after collection.

Another subject of the invention is a composite combining at least one organic and/or inorganic material and reinforcing strands, said strands consisting entirely or partly of glass strands coated with the sizing composition described above. The organic material may consist of one or more thermoplastic or thermosetting polymers, and the inorganic material may for example be a cementitious material.

The glass content within the composite is generally between 5 and 60% by weight.

The examples given below illustrate the invention without however limiting it.

In these examples, the properties of the strand and the composites were evaluated under the following conditions:

[symbol] the loss on ignition of the sized glass strand was measured under the conditions in the ISO 1887 standard given in %;

[symbol] the abrasion resistance of the strand was determined by measuring the amount of fuzz (in the form of fibrils) formed by making 1 kg of 300 tex strand coming from a cake or 3 kg of strand unwound from a 1600 tex assembled roving on a feed system composed of a series of 4 or 6 bars rolling at a speed of 200 m/min. The amount of fuzz is expressed in mg/100 g of strand;

[symbol] the tenacity of the strand was determined by measuring the tensile breaking force under the conditions in the ISO 3341 standard expressed in N/tex;

[symbol] the capability of the strand to be impregnated with a resin was measured under the following conditions: 40 m of strand were cut into lengths of 30 cm, which were placed in parallel on a sheet of Mylar®, 20 g of a resin, consisting of 100 parts by weight of an epoxy resin (PRIME® 20 LV sold by SP SYSTEMES) and 25 parts by weight of a hardener (PRIME® 20 SLOW HARDENER sold by SP SYSTEMES), were deposited, a sheet of Mylar®0 was placed on top and the assembly compressed by means of a roller. The composite sheet obtained was heated for 2 hours at 105° C.

The quality of the impregnation of the strands by the resin in the composite sheet was assessed visually according to a rating that varies from 1=good impregnation (invisible filaments) to 5=poor impregnation (many white strands);

[symbol] the tensile strength of the strand was measured after a wet aging treatment in a chamber saturated with water vapor at 80° C.;

[symbol] the wet aging resistance was evaluated on a composite sheet with parallel strands under the conditions in the ISO 9291 standard, the resin used consisting of 100 parts by weight of an epoxy resin (PRIME® 20 LV sold by SP SYSTEMES) and 26 parts by weight of a hardener (PRIME® 10 EXTRASLOW HARDENER sold by SP SYSTEMES). The test pieces cut from the composite sheet were treated for 72 hours in boiling water.

The strength in 3-point bending was measured on the test pieces in the transverse direction and the strength for a glass content of 100% was calculated. The stresses are expressed in MPa;

[symbol] the fatigue test was carried out under the conditions of the NFT 51-120-4 standard. The stress applied to the specimens was equal to 700 MPa. The maximum number of cycles before failure, obtained for the best specimen and the average of the number of cycles (calculated on 5 test specimens) were determined.

In the examples, the following raw materials were used for preparing the sizing composition:
film-forming agents:
   Polyvinyl acetate: sold under the reference VINAMUL® 8828 by Vinamul, with a 52% solids content;
   Polyvinyl acetate, with a 50000 molecular weight, sold under the reference VINAMUL® 8852 by Vinamul, having a 55% solids content;
   Bisphenol A epoxy resin, sold under the reference EPIREZ® 3510 W 60 by Resolution, with a 60% solids content;
   Bisphenol A epoxy resin/1-methoxy-2-propanol mixture, sold under the reference NEOXIL® 962D by DSM, with a 40% solids content;
   mixture of bisphenol A epoxy resin (30.7% by weight), sold under the reference ARALDITE CY 207 by Huntsman, and a polyester resin (10% by weight), sold under the reference NORSODYNE So56 by Cray Valley, with a solids content of 64%; and
   an epoxy resin, sold under the reference FILCO® 310 by COIM, with a solids content of 52%;
coupling agents:
   γ-methacryloxypropyltriethoxysilane, sold under the reference SILQUEST® A-174NT by GE Silicones, with a solids content of 80% (the compound was prehydrolyzed in the presence of acetic acid);
   γ-aminopropyltriethoxysilane, sold under the reference SILQUEST® A-1100 by GE Silicones, with a solids content of 100%;
   a silylated polyazamide, sold under the reference SILQUEST® A-1387 by GE Silicones, with a solids content of 50%.
   γ-glycidoxypropyltriethoxysilane, sold under the reference SILQUEST® A-187 by GE Silicones, with a solids content of 100%;
nanoparticles:
   clay (montmorillonite) modified by ion exchange with a quaternary ammonium salt, sold under the reference Dellite® 67G by Laviosa Chimica Mineraria, with a solids content of 100%;
   composite particles of a clay (montmorillonite) modified by ion exchange with a quaternary ammonium salt (sold under the reference Dellite® 67G by Laviosa Chimica Mineraria) and of a bisphenol A diglycidol ether resin (sold under the reference ARALDITE® GY 250 by Huntsman) as an aqueous emulsion, with a solids content of 50.4%, hereafter called Dellite® 67G+ARALDITE;
   a clay (montmorillonite) modified by ion exchange with a quaternary ammonium salt (sold under the reference Dellite® 67G by Laviosa Chimica Mineraria) treated in dispersion in a PEG 300 with N-styrylaminoethyl-γ-aminopropyltrimethoxysilane (sold under the reference SILQUEST A-1128 by GE Silicones), with a solids content of 100%, hereafter called Dellite® 67G+A-1128/PEG;
   a clay (montmorillonite) modified by ion exchange with a quaternary ammonium salt (sold under the reference Dellite® 67G by Laviosa Chimica Mineraria) treated in dispersion in PEG 300 with N-styrylaminoethyl-γ-aminopropyltrimethoxysilane (sold under the reference SILQUEST A-1128 by GE Silicones), with a solids content of 100%, hereafter called Dellite® 67G +A-11228/PEG;
   a clay (montmorillonite), sold under the reference Dellite® HPS by Laviosa Chimica Mineraria, with a solids content of 100%;
   silica beads in a bisphenol-A epoxy resin sold under the reference NANOPOX® by Hanse Chemie, in aqueous dispersion, with a solids content of 56%;
   boehmite in platelet form:
      Boehmite A: modified by an aminosilane (sold under the reference SILQUEST A-1100 by GE Silicones); 1% of the weight of the nanoparticles, with a solids content of 100%;
      Boehmite B: modified by an aminosilane (sold under the reference SILQUEST A-1100 by GE Silicones); 2% of the weight of the nanoparticles, with a solids content of 100%; and
      Boehmite C: modified by an methacryloxysilane (sold under the reference SILQUEST A-174 by GE Silicones); 1% of the weight of the nanoparticles, with a solids content of 100%;
plasticizer:
   a dipropylene glycol dibenzoate/diethylene glycol dibenzoate mixture, sold under the reference K-FLEX® 500 by Euram, with a solids content of 100%; and
   ethoxylated fatty alcohols sold under the reference SETILON® KN by Cognis, with a solids content of 57%;
viscosity-regulating agent:
   carboxymethylcellulose, sold under the reference BLANOSE® 7HC by Hercules, with a solids content of 100%;
   hydroxyethylcellulose, sold under the reference NATROSOL® 250 HBR by Aqualon, with a solids content of 100%; and
dispersing agents and lubricating agents:
   a polyether modified by polyacrylate groups, sold under the reference TEGO DISPERS® 750 W by Degussa, with a solids content of 40%;
   a polymeric dispersant, sold under the reference SOLSPERSE® 27000 by Avecia, with a solids content of 100%;
   an alkylamido-amine, sold under the reference SODAMINE® P 45 by Arkema, with a solids content of 100%;
   an alkylbenzene, sold under the reference TORFIL® LA4 by Lamberti, with a solids content of 100%,
   a polyethyleneimine salt, sold under the reference EMERYE 6760 by Cognis, with a solids content of 50%;
   a mixture of an ethoxylated alcohol and glycerol esters, which is sold under the reference TEXLUBE® NI/CS2 by Achitex, with a solids content of 100%;
   a mineral oil, sold under the reference CIRRALUG® VT01 by Petronaphte, with a solids content of 98%; and
   an alkylamido-amine acetate, sold under the reference CATIONIC SOFTENER FLAKES® by Goldschmidt, with a solids content of 100%; and
antifoaming agent:
   a polyether, sold under the reference TEGO FOAMEX® 830 by Degussa, with a solids content of 100%.

### EXAMPLES 1 TO 7

These examples illustrate base glass strands coated with sizing compositions containing clay nanoparticles.

The sizing compositions contain the raw materials given in Table 1 (in percent by weight).

Dispersion D was prepared under the following conditions:
stirring until homogenization (Example 1);
mechanical stirring for 1 hour followed by Ultraturax® treatment at 9000 rpm for 5 minutes (Examples 2, 6 and 7); and
homogenization of the constituents, ultrasonic treatment for 30 minutes, and Ultraturax® treatment at 9000 rpm for 5 minutes (Examples 3 to 5).

In Example 7, the clay particles were brought into contact with 1,4-butanediol for 3 hours before being dispersed under the aforementioned conditions.

The sizing compositions were deposited on E-glass filaments 13 μm in diameter before being assembled into a single strand, which was wound in the form of a cake.

The properties of the strand obtained are given in Table 1.

The size of Example 1 was adapted to the production of an SMC (sheet molding compound) in which the amount of fuzz is an important criterion for use of the product. Compared with reference Example 1 containing no nanoparticles, the strands of Examples 2 to 7 according to the invention exhibit better abrasion resistance given by an appreciably smaller amount of fuzz.

The abrasion resistance depends on the amount of nanoparticles in the size: the strands of Examples 2 and 3 have a lower amount of fuzz than Examples 4 to 7.

TABLE 1

| | Ex. 1 | | | | | | |
|---|---|---|---|---|---|---|---|
| | (comparative) | Ex. 2 | Ex. 3 | Ex. 4 | Ex. 5 | Ex. 6 | Ex. 7 |
| Dispersion D | | | | | | | |
| Dellite ® 67G | — | 0.85 | 0.50 | 0.42 | 0.42 | 0.42 | 0.42 |
| Dellite ® HPS | — | — | 0.50 | — | — | — | — |
| TEGO DISPERS ® 750 W | — | — | 0.17 | 0.08 | 0.08 | 0.08 | 0.08 |
| TEGO FOAMEX ® 830 | — | 0.05 | — | 0.05 | 0.05 | 0.05 | 0.05 |
| SOLSPERSE ® 27000 | — | 0.68 | — | — | — | — | — |
| VINAMUL ® 8828 | 6.92 | 6.92 | 6.92 | 6.92 | 6.92 | 6.92 | 6.92 |
| 1,4-butanediol | — | — | — | — | — | — | 1.5 |
| Emulsion E | | | | | | | |
| SILQUEST ® A-174 | 0.29 | 0.29 | 0.29 | 0.29 | 0.29 | 0.29 | 0.29 |
| SILQUEST ® A-1100 | 0.19 | 0.19 | 0.19 | 0.19 | 0.19 | 0.19 | 0.19 |
| BLANOSE ® 7HC | — | 0.19 | — | 0.14 | 0.14 | 0.10 | 0.10 |
| VINAMUL ® 8852 | 3.58 | 3.58 | 3.58 | 3.58 | 3.58 | 3.58 | 3.58 |
| K-FLEX ® 500 | 0.25 | 0.25 | 0.25 | 0.25 | 0.25 | 0.25 | 0.25 |
| FILCO ® 310 | 2.4 | 2.4 | 2.4 | 2.4 | 2.4 | 2.4 | 2.4 |
| TORFIL ® LA4 | — | — | — | — | 0.3 | 0.3 | 0.3 |
| EMERY ® 6760 | 0.2 | 0.2 | 0.2 | — | — | — | — |
| Water, qsp 100 | | | | | | | |
| Properties of the strand | | | | | | | |
| Linear density (tex) | 292 | 258 | 278 | 275 | 289 | 290 | 284 |
| Loss on ignition (%) | 1.60 | 1.68 | 1.37 | 1.55 | 1.36 | 1.62 | 1.75 |
| Fuzz (mg/100 g) | 158 | 5 | 18 | 30 | 33 | 43 | 32 |

### EXAMPLES 8 TO 10

These examples illustrate assembled glass strands coated with sizing compositions containing clay nanoparticles.

The sizing compositions contain the raw materials given in Table 2 (in % by weight relative to the total volume).

Dispersion D was treated under the following conditions:
mechanical stirring for 1 hour followed by Ultraturax® treatment at 9000 rpm for 5 minutes (Examples 8 and 9); and
stirring until homogenization (Example 10).

The sizing compositions were deposited on E glass filaments 16 pm in diameter before they were assembled into 4 strands of 100 tex linear density and wound as a cake on a single support. The strands were then extracted from four cakes and assembled into a single strand (of 1600 tex) which was wound in the form of a roving.

The characteristics of the strand obtained are given in Table 2.

TABLE 2

| | | | Ex. 10 |
|---|---|---|---|
| | Ex. 8 | Ex. 9 | (comparative) |
| Dispersion D | | | |
| Dellite ® 67G | 0.4 | — | — |
| Dellite ® HPS | — | 0.4 | — |
| TEGO DISPERS ® 750 W | 0.12 | 0.12 | — |
| TEGO FOAMEX ® 830 | 0.05 | 0.05 | — |
| VINAMUL ® 8828 | 6.92 | 6.92 | 6.92 |
| Emulsion E | | | |
| SILQUEST ® A-174 | 0.29 | 0.29 | 0.29 |
| SILQUEST ® A-1100 | 0.19 | 0.19 | 0.19 |
| BLANOSE ® 7HC | 0.14 | 0.14 | 0.14 |
| VINAMUL ® 8852 | 3.45 | 3.45 | 3.45 |
| K-FLEX ® 500 | 0.25 | 0.25 | 0.25 |
| FILCO ® 310 | 2.4 | 2.4 | 2.4 |
| TORFIL ® LA4 | 0.3 | 0.3 | — |
| Water, qsp 100 | | | |
| Properties | | | |
| Base strand loss on ignition (%) | 1.71 | 1.82 | 1.80 |
| Roving fuzz (mg/100 g) | 27 | 57 | 123 |

The abrasion resistance of the strands of Examples 8 and 9 according to the invention that have undergone additional assembly steps was higher than for the reference strand (Example 10).

### EXAMPLES 11 TO 17

These examples illustrate base glass strands coated with sizing compositions containing clay or silica nanoparticles.

The sizing compositions contain the raw materials given in Table 3 (in % by weight relative to the total volume).

Dispersion D was treated under the following conditions:
mechanical stirring for 1 hour followed by Ultraturax® treatment at 5000 rpm for 5 minutes (Examples 11 to 13);
vigorous mechanical stirring for 1 hour (Examples 14 and 15); and
no stirring (Examples 17 and 18).

The sizing compositions were deposited on E-glass filaments 13 μm in diameter before being assembled into a single strand, which was wound as a cake.

The glass strands of Examples 11 to 15 according to the invention exhibit excellent abrasion resistance compared with the reference strands (Examples 16 and 17). The reference strands broke in the test with 6 bars and gave a higher amount of fuzz than the strands of the invention in the test with 4 bars.

The toughness of the strands of Examples 11 to 15 is equivalent to that of the strands of comparative Examples 16 and 17. The observed variations in the toughness are associated with modifications in the integrity of the strand by the nanoparticles.

TABLE 3

| | | | | | | Ex. 16 | Ex. 17 |
|---|---|---|---|---|---|---|---|
| | Ex. 11 | Ex. 12 | Ex. 13 | Ex. 14 | Ex. 15 | (comparative) | (comparative) |
| Dispersion D | | | | | | | |
| Dellite ® 67G | 0.24 | — | — | — | — | — | — |
| Dellite ® 67G + A-1128/water | — | 0.24 | — | — | — | — | — |
| Dellite ® 67G + A-1128/PEG | — | — | 0.24 | — | — | — | — |
| Dellite ® 67G + ARALDITE | — | — | — | 2.5 | — | — | — |
| NANOPOX ® | — | — | — | — | 6.4 | — | — |
| TEGO FOAMEX ® 830 | 0.05 | — | — | — | — | — | — |
| EPIREZ ® 3510 W 60 | 4.0 | 4.0 | 4.0 | 1.7 | — | 4.0 | 4.0 |
| Emulsion E | | | | | | | |
| SILQUEST ® A-174 | 0.45 | 0.45 | 0.45 | 0.45 | 0.45 | 0.45 | 0.45 |
| SILQUEST ® A-1387 | 0.20 | 0.20 | 0.20 | 0.20 | 0.20 | 0.20 | 0.20 |
| NATROSOL ® 250 HBR | 0.20 | 0.20 | 0.20 | 0.20 | 0.20 | 0.20 | — |
| NEOXIL ® 962D | 2.5 | 2.5 | 2.5 | 2.5 | 2.5 | 2.5 | 2.5 |
| SETILON ® KN | 0.1 | 0.1 | 0.1 | 0.1 | 0.1 | 0.1 | 0.1 |
| TEXLUBE ® NICS2 | 0.3 | 0.3 | 0.3 | 0.3 | 0.3 | 0.3 | 0.3 |
| Water, qsp 100 | | | | | | | |
| Properties of the strand | | | | | | | |
| Linear density (tex) | 292 | 279 | 294 | 297 | 277 | 292 | 286 |
| Loss on ignition (%) | 1.23 | 0.73 | 0.68 | 0.75 | 0.79 | 1.01 | 0.69 |
| Toughness (N/tex) | 0.49 | 0.52 | 0.51 | 0.47 | 0.61 | 0.56 | 0.62 |
| Fuzz (mg/100 g) - 6 bars | 28 | 24 | 25 | 36 | 18 | strand broke | strand broke |
| Fuzz (mg/100 g) - 4 bars | n.d. | n.d. | n.d. | n.d. | n.d. | 54 | 58 |
| Impregnation | 2 | 2 | 1 | 3 | 1 | n.d. | 4 |

n.d: not determined

### EXAMPLES 18 TO 21

These examples illustrate base glass strands coated with sizing compositions containing boehmite nanoparticles.

The sizing compositions contained the raw materials given in Table 4 (in % by weight relative to the total volume).

Dispersion D was prepared under the following conditions:
no stirring (Example 18); and
Ultraturax® treatment at 5000 rpm for 5 minutes (Examples 19 to 21).

The dispersion was a gel.

The sizing compositions were deposited on E-glass filaments 13 μm in diameter before they were assembled into a single strand, which was wound as a cake.

TABLE 4

| | Ex. 18 | | | |
|---|---|---|---|---|
| | (comparative) | Ex. 19 | Ex. 20 | Ex. 21 |
| Dispersion D | | | | |
| Boehmite A | — | 0.56 | — | — |
| Boehmite B | — | — | 0.56 | — |
| boehmite C | — | — | — | 0.56 |
| EPIREZ ® 3510 W 60 | 2.92 | 2.92 | 2.92 | 2.92 |
| Emulsion E | | | | |
| SILQUEST ® A-174 | 0.39 | 0.39 | 0.39 | 0.39 |
| SILQUEST ® A-1387 | 0.20 | 0.20 | 0.20 | 0.20 |
| SILQUEST ® A-187 | 0.28 | 0.28 | 0.28 | 0.28 |
| NEOXIL ® 962D | 1.75 | 1.75 | 1.75 | 1.75 |
| SETILON ® KN | 0.18 | 0.18 | 0.18 | 0.18 |
| CIRRALUG ® VT01 | 0.51 | 0.51 | 0.51 | 0.51 |
| TEXLUBE ® NI/CS2 | 1.25 | 1.25 | 1.25 | 1.25 |
| Water, qsp 100 | | | | |
| Properties of the strand | | | | |
| Linear density (tex) | 577 | 613 | 585 | 576 |
| Loss on ignition (%) | 0.54 | 0.53 | 0.56 | 0.60 |
| Toughness (N/tex) | 0.46 | 0.42 | 0.46 | 0.47 |
| Fuzz (mg/100 g) | trace | trace | 15 | 6 |

It was observed that introducing the nanoparticles into the sizing composition does not degrade the performance of the strand: the toughness is equivalent to the reference strand of Example 18 and the abrasion resistance, much higher than in Examples 20 and 21 is acceptable.

Composite sheets were produced from the strands of Examples 18 to 20, with the strands parallel and impregnated with the epoxy resin, as defined above, and the wet aging resistance of these composite sheets was measured. The results are given in the following Table 5:

TABLE 5

| | Ex. 18 | | |
|---|---|---|---|
| | (comparative) | Ex. 19 | Ex. 20 |
| Wet aging test: | | | |
| Strength (transverse direction) | | | |
| in MPa: | | | |
| Initial | 56.40 | 68.10 | 70.00 |
| After aging | 46.50 | 48.60 | 49.30 |
| 100%-Glass strength in MPa: | | | |
| Initial | 1996.55 | 1958.13 | 1994.16 |
| After aging | 1638.42 | 1630.96 | 1595.33 |
| Fatigue test: | | | |
| Maximum number of cycles | 659538 | 1410986 | 771416 |
| | (—) | (+114%) | (+17%) |
| Average number of cycles | 411732 | 649532 | 501937 |
| | (—) | (+57%) | (+22%) |

The strands according to the invention show a significant improvement in the wet aging and fatigue performance. In particular, Example 19 shows a 114% increase in the maximum number of cycles and a 57% increase in the average number of cycles before the test specimen failed.

### EXAMPLES 22 TO 27

These examples illustrate base glass strands coated with sizing compositions containing boehmite nanoparticles.

The sizing compositions contained the raw materials given in Table 6 (in % by weight relative to the total volume).

Dispersion D was treated under the following conditions:
mechanical stirring for 20 minutes (Example 22); and
mechanical stirring for 20 minutes followed by Ultraturax® treatment at 5000 rpm for 30 minutes (Examples 23 to 25).

The sizing compositions were deposited on E-glass filaments 13 μm in diameter before they were assembled into a single strand, which was wound as a cake.

TABLE 6

| | Ex. 22 | | | |
|---|---|---|---|---|
| | (comparative) | Ex. 23 | Ex. 24 | Ex. 25 |
| Dispersion D | | | | |
| Boehmite A | — | 0.34 | — | — |
| Boehmite B Boehmite C | — | | 0.34 | — |
| SODAMINE ® P 45 | — | — | — | 0.34 |
| Emulsion E | | | | |
| SILQUEST ® A-174 | 0.07 | 0.07 | 0.07 | 0.07 |
| SILQUEST ® A-1387 | 0.21 | 0.21 | 0.21 | 0.21 |
| CATIONIC | 0.28 | 0.28 | 0.28 | 0.28 |
| SOFTENER | | | | |
| FLAKES ® | | | | |
| ETS4 ® | 0.11 | 0.11 | 0.11 | 0.11 |
| Water, qsp 100 | 5.04 | 5.04 | 5.04 | 5.04 |
| Properties of the strand | | | | |
| Linear density (tex) | 176 | 187 | 196 | 198 |
| Loss on ignition (%) | 0.73 | 0.75 | 0.72 | 0.43 |
| Toughness (N/tex) | 0.62 | 0.55 | 0.58 | 0.60 |
| Fuzz (mg/100 g) | 39 | 0 | 0 | 0 |
| Ageing: | | | | |
| 0-Day strength (MPa) | 1597 | 1501 | 1443 | 1549 |
| 14-Day strength (MPa) | 634 | 698 | 1095 | 946 |
| | — | (+11.0%) | (+72.7) | (+49.2) |

The abrasion resistance of the strands of Examples 23 to 25, measured by the amount of fuzz formed, is very much greater than that of the strand of Example 22 given for comparison for equivalent toughness.

The strength of these strands is of the same order of magnitude as Comparative Example 22 in the initial state and improved after 14 days of aging (with an increase ranging from 11 to 72.7%).

1. A glass strand coated with a sizing composition which comprises (in % by weight):
25 to 90% of at least one film-forming agent;
3 to 25% of at least one coupling agent; and
2 to 18% of nanoparticles.

2. The glass strand as claimed in claim 1, characterized in that the film-forming agent is chosen from polyvinyl acetates, polyesters, epoxies, polyacrylics, polyurethanes, polyamides, cellulose polymers and blends of these compounds.

3. The glass strand as claimed in claim 2, characterized in that the film-forming agent is chosen from polyvinyl acetates, epoxies, blends containing at least one epoxy and at least one polyester, and polyurethanes.

4. The glass strand as claimed in claim 1, characterized in that the film-forming agent represents 50 to 90% by weight of the sizing composition.

5. The glass strand as claimed in claim 1, characterized in that the coupling agent is chosen from hydrolyzable compounds belonging to the group consisting of silanes, siloxanes, titanates, zirconates and mixtures of these compounds.

6. The glass strand as claimed in claim 5, characterized in that the coupling agent is a silane.

7. The glass strand as claimed in claim 1, characterized in that the coupling agent represents 5 to 18% by weight of the sizing composition.

8. The glass strand as claimed in claim 1, characterized in that the nanoparticles comprise at most 30% by weight of a mineral material.

9. The glass strand as claimed in claim 8, characterized in that the nanoparticles are based on clay, boehmite or silica.

10. The glass strand as claimed in claim 1, characterized in that the nanoparticles are treated with an agent that helps to slow down the rate of diffusion of water.

11. The glass strand as claimed in claim 10, characterized in that said agent is a compound of formula RₐXY₄₋ₐ, in which:
R represents a hydrogen atom or a hydrocarbon radical containing 1 to 40 carbon atoms, it being possible for said radical to be linear, branched or cyclic, saturated or unsaturated, possibly containing one or more O or N heteroatoms or possibly being substituted with one or more amino, carboxylic acid, epoxy or amido groups, and the R groups being identical or different;
X represents Si, Zr or Ti;
Y is a hydrolyzable group, such as an alkoxy containing 1 to 12 carbon atoms, possibly containing one or more heteroatoms O or N or a halogen; and a is equal to 1, 2 or 3.

12. The glass strand as claimed in claim 11, characterized in that the compound is an organosilane.

13. The glass strand as claimed in claim 1, characterized in that the nanoparticles represent 2.5 to 15% by weight of the sizing composition.

14. An aqueous sizing composition for a glass strand as claimed in claim 1, characterized in that it comprises:
1.5 to 15% of at least one film-forming agent;
0.15 to 4% of at least one coupling agent;
0.1 to 4% of nanoparticles;
0 to 2% of at least one lubricating agent;
0 to 4% of at least one dispersing agent; and
0 to 4% of at least one viscosity-regulating agent.

15. The sizing composition as claimed in claim 14, characterized in that it has a solids content that varies from 2 to 35%.

16. A method for preparing the sizing composition as claimed in claim 14, which comprises the following steps:
a) producing a dispersion D of the nanoparticles in water optionally containing a dispersing agent;
b) introducing the film-forming agent, the coupling agent and the aforementioned optional constituents in water in order to form an emulsion E, and
c) blending the dispersion D with the emulsion E.

17. The method as claimed in claim 16, characterized in that the dispersing in step a) is carried out under high shear conditions.

18. A composite comprising at least one organic and/or inorganic material and glass reinforcement strands, characterized in that said strands consist entirely or partly of glass strands as claimed in claim 1.

19. The composite as claimed in claim 18, characterized in that it contains 5 to 60% by weight of glass.
